(19) United States
(12) Patent Application Publication
(10) Pub. No.: US 2014/0240166 A1
(43) Pub. Date: Aug. 28, 2014

(54) DEVICE FOR CLUTTER-RESISTANT TARGET DETECTION

(71) Applicants: Jean-Marc Cortambert, Toulon (FR); Jacques Dulost, Cadenet (FR); Dominique Medynski, Salon de Provence (FR); Serge Roques, Mouries (FR)

(72) Inventors: Jean-Marc Cortambert, Toulon (FR); Jacques Dulost, Cadenet (FR); Dominique Medynski, Salon de Provence (FR); Serge Roques, Mouries (FR)

(73) Assignee: OFFICE NATIONAL D'ETUDES ET DE RECHERCHES AEROSPATIALES (ONERA), Châtillon (FR)

(21) Appl. No.: 14/235,659

(22) PCT Filed: Jul. 12, 2012
(86) PCT No.: PCT/FR2012/051653

§ 371 Date: May 6, 2014

(30) Foreign Application Priority Data
Jul. 29, 2011 (FR) 1156970

(51) Int. Cl. G01S 13/44

(52) U.S. Cl. CPC G01S 13/44
USPC 342/90

(57) ABSTRACT

The invention relates to a device for passively or actively detecting a target which scatters a useful signal and which is immersed in an observed area comprising elements that are likely to generate clutter echoes forming a non-useful signal, the useful signal having a coherent scattering lobe that is greater than that of the non-useful signal for a given wavelength and given direction, said device including means for receiving the signal scattered by the target, said receiving means including: at a given moment t, at least two separate reception portions having the same polarization, each portion including at least one receiver and one phase center; and a processing means enabling the mutual correlation between at least two received signals, or between at least two signals constructed from signals received at a moment t, each of said received signals being received by a receiver of one of said at least two separate reception portions, characterized in that the phase centers of said at least two reception portions are arranged such that the both of the latter are located in the coherent scattering lobe of a possible useful signal and such that both of the latter are not located in the coherent scattering lobe of the non-useful signal, so as to enable said processing means to detect a possible useful signal present of the non-useful signal, the minimum required distance between said phase centers being that which is required for observing a first decrease in the coefficient of correlation of said at least two constructed signals.

### TECHNICAL FIELD

The present invention relates to the field of clutter-resistant antennas. More particularly, the invention relates to radars or sonars and their processings or their arrangements such as to limit the disturbing effects related to clutter during signal detection.

### BACKGROUND

A radar generally comprises a transmitting part which consists of a transmitting system emitting a string of electromagnetic pulses, the latter propagating in the atmosphere up to a target. A second so-called receiving part makes it possible to receive and to analyze an echo of the target. That is to say the target returns a small part of the energy received to the radar receiver. This energy arrives at the radar receiver which detects it.

Generally, a radar does not allow perfect detection of the echo. In particular, one reason for this imperfection is that the receiver itself generates inherent noise, also called thermal noise, which interferes with the detections. This noise may either limit the detection of genuine echoes, or generate false alarms.

In addition to this first limitation, it is necessary to consider that in practice the detection capabilities of a radar are limited by the presence of undesirable echoes that may originate from atmospheric disturbances, such as the presence of clouds or rain, or else disturbances arising from interfering reflections such as the reflections of the waves on the ground or on the sea.

These disturbing echoes are designated as a whole by the name clutter.

In the absence of specific processing, the target is easily drowned in clutter, for example sea clutter. In this case no detection is possible.

The conventional systems treat the problem by incorporating processings based on Doppler filtering. The effect of these processings is to separate the echoes received as a function of their radial-speed signature.

Generally, clutter has a slow radial speed. A suitably matched filter makes it possible to eliminate the slow echoes and can detect the other targets.

A drawback persists in respect of speed-ambiguous radars for which the detection of slow targets remains very difficult.

The international application published under the number WO 2007/002396 presents a system and a method making it possible to detect a target and to obtain information on said target with the help of multisensor detection. The present application raises the problem area of the disturbances of receiver measurements induced by clutter. This document discloses the use of a plurality of sensors separated in space and taken pairwise to analyze and filter the signals received. The sensors are used to eliminate or reduce in particular the atmospheric disturbances so as to take them into account in the correlation computations for the signals received. The spatial separation of the sensors is used in such a way as to filter a large part of the clutter.

However, this method is expensive from a data processing point of view since it is necessary to implement a specific filtering of the clutter-related disturbances. Moreover, this method is dependent on the context of use and must be parametrized according to the configuration of use.

The patent application published under the number GB 2 356 096 relates to the technical problem of the filtering of multipaths, this being different from the technical problem of the filtering of clutter, these two kinds of noise differing in their nature.

Indeed, a multipath signal is characterized by the coherent superposition (addition in amplitude and in phase) of two signals originating from the target, that is to say usually at the same distance and doppler as the latter. In general, the effect of a multipath is to falsify the angular measurement of the target (especially the angle of elevation, but also the azimuth in certain cases). In the worst case where the 2 paths are in phase opposition, the target is no longer detected.

On the other hand, clutter is a signal generated by the presence of multiple scatterers inside the radar distance-angle resolution bin; it does not therefore contain any signal originating from the target and is in general at zero or low doppler. It may therefore mask slow targets whose echo is of low amplitude. For these targets, it is likened to a strengthening of the measurement noise. Very often, the clutter is referred to a dummy phase center situated at the center of the radar resolution bin.

The multi-path signal therefore comprises information relating to the target even if this information is delayed, whereas a clutter ray originates from the environment which transmits or reflects the signal of the transmitter and does not therefore comprise any information relating to the target.

This difference is fundamental, in particular for processings based on the correlation of the useful signal with that of the non-useful signal. In GB 2 356 096, the useful signal is the most correlated part of the signals received by the single phase center relative to the modulated signal transmitted (this is the signal transmitted by the transmission antenna and then scattered by the target directly toward the reception antenna). We shall see that, in the invention, the useful signal is the correlated part of the signals received by the 2 phase centers (this is the signal transmitted by the transmission antenna and then scattered by the target and then received by the reception antenna with or without multipath). In both cases, of course, the non-useful signal is the signal received minus the useful signal: in document GB 2 356 096 it comprises the multi-path signal, whereas, in the invention, it comprises the clutter signal.

Moreover, the technical solution proposed in GB 2 356 096 is not the same which is proposed further on proposed according to the invention.

Indeed, in document GB 2 356 096, at a given instant, the transmission antenna has only a single phase center, this phase center transmitting the signal and then having to be displaced to modulate the signal transmitted so as to decorrelate the multi-path signals from the useful signal since this change of position of the phase center on transmission changes the phase relation between the direct-path signal received and the multipaths. Document GB 2 356 096 does not describe the processing of the signal performed after the receiver, but it may be said that this device does not filter the clutter, as confirmed by the absence of any mention of this filtering. Indeed, their processing does not make it possible to decorrelate the clutter from the useful signal, since the signal transmitted by their antenna, reflected around the target and returning directly to the phase center, is also modulated like the useful signal and has not undergone the variation of modulation caused by a multipath.

In the invention, as will be seen hereinafter, there are simultaneously at least two phase centers, and they do not need to be displaced, once they are positioned an appropriate distance from one another. Moreover, as will also be seen hereinafter, the filtering of the clutter in the invention adopts an opposite approach from that of the state of the art which comprises remaining as coherent as possible so as to be able to detect fast targets.

Moreover, in GB 2 356 096, the elements are necessarily transmitters/receivers since it entails correlating the signals received with the modulated signal transmitted, whereas, in the invention, no provision is made for modulation of the signal transmitted and the reception antenna can therefore be passive and therefore discreet.

Finally, the device and the method of the invention do not make it possible to filter multi-paths.

As we shall see, the device and the method of the invention are therefore clearly different from those described in patent application GB 2 356 096, the former ones making it possible to filter the clutter but not the multipaths and the latter ones making it possible to filter the multi-paths but not the clutter.

### BRIEF SUMMARY OF THE INVENTION

The invention makes it possible to avoid the previously cited drawbacks and to effectively decrease the effects of clutter, of surface or volume type, for various natures of signals received (electromagnetic, sound, vibratory, etc.).

A first advantageous embodiment of the invention is a detection device, passive or active, for detecting a target able to scatter a useful signal that may originate from a collaborative or non-collaborative source signal, and situated in an observed zone comprising elements able to generate clutter echoes, said clutter echoes forming, together with noise, a non-useful signal, said device comprising means for receiving the useful signal, the useful signal, which is the source signal backscattered by the target, having a wider coherent scattering lobe than that of the non-useful signal for a considered observed wavelength and in the direction going from the target to the barycenter of the positions of said reception means, said reception means comprising:
at a given instant t, at least two distinct reception portions of like polarization, each portion comprising at least one receiver and a phase center; and
processing means allowing correlation between at least two signals constructed from signals received at an instant t, each of said signals received being received by a receiver of one of said at least two distinct reception portions,

characterized in that the phase centers of said at least two reception portions are disposed in such a way as to both be situated in said coherent scattering lobe of the useful signal and to not both be situated in said coherent scattering lobe of the non-useful signal, so as to allow said processing means to distinguish the possible useful signal from the non-useful signal, the necessary minimum distance between said phase centers being that for observing a first drop in the correlation of said at least two constructed signals.

A “phase center” can be defined as the point serving as reference for the measurements of phases on an antenna. This point is computed by the measurement of the equiphase surfaces in the antenna lobe. Spheres whose center is said phase center are theoretically obtained. For a “phased” array, the phase center is close to the barycenter of the positions of the elements of the array. It is in all cases included in the area delimited by the array. For an observed clutter zone, generating clutter, or for a target, the phase center is the barycenter of the positions of the bright points, weighted by the amplitude of the wave that they (back)scatter.

A “coherent scattering lobe” is defined as follows: the characteristics of the echo produced by a radar wave striking an arbitrary target are explained by the spawning of induced currents usually circulating on the surface of the target. As a first approximation (geometric optics), the target is represented as a set of bright points distributed over its surface. The same holds for the clutter zone generating the clutter noise. This gives a random character to the backscattering phenomenon. There exists a spatial zone where the statistical behavior of the amplitude of the wave is maintained (notion of spatial coherence). In the far field, the domain of application of the present invention, the definition of this zone, called the coherent scattering lobe in the present application, is expressed simply by the points situated between 2 observation points separated angularly by less than I/L radians, where I is the working wavelength, and L the characteristic dimension of the target in a direction perpendicular to the observation axis, the vertex of the angle being the phase center of the source considered (the clutter zone or the target).

This explains that the target, of smaller characteristic dimension than that of the clutter zone, remains coherent over a wider angular extent than the clutter.

In this embodiment, the detection device can be active, that is to say it comprises an antenna for transmitting a signal able to be scattered by any possible target.

The detection device can also be passive, that is to say it may not comprise any antenna for transmitting a signal illuminating the zone to be observed. The useful signal can then be the scattering of a signal originating from another source, such as another radar or a carrier frequency of a civil telecommunications network, or else be a signal emitted by the target itself, such as for example its thermal emission.

This possibility of the invention of operating in passive mode results from the fact that the signals received by said reception means do not need to be consistent with a signal illuminating said observed zone able to contain a target. On the other hand, a necessary condition is that the useful signal, scattered by the target, is coherent on said at least two receivers.

In the case of illumination by a civil telecommunications network, the illumination zone may be of very large dimension, but the size of the coherent scattering lobe, depending directly on the width of the illumination zone, this lobe can therefore be of very small width, thereby allowing filtering of the clutter with a very small separation of the phase centers.

Indeed, a significant characteristic of the invention results from the choice of the separation of the phase centers of reception portions of the reception means as is detailed subsequently.

Subsequently, the description mentions mainly two “receiving portions” to indicate either two sub-arrays of one and the same antenna or two distinct reception antennas. A receiving portion is also called a “reception portion” or else a “reception means portion”.

In the linear case, these portions are named either: “linear portion”, “linear path” or “line portion”.

Each receiving portion of the reception means comprises a phase center.

The two distinct portions of the reception means of the device of the invention can be of various natures. This may involve two distinct antennas but also two sub-arrays of receivers of one and the same antenna.

In all the embodiments, it is possible to estimate the width of the coherence lobe of the non-useful signal and to configure a sufficient distance separating the phase centers of the reception portions.

In the case where information relating to the geometry of the possible illumination of the observed zone, in particular information relating to the position and to the geometry of a transmission antenna, are known a priori, this estimation is accessible to the person skilled in the art.

In all cases, it is always possible to vary the positions of one or more phase centers until an appreciable decorrelation of the non-useful components of the signals received by the two receivers of the reception portions associated with these phase centers is obtained.

The invention is particularly propitious to the application of radars aboard ships or aircraft.

The invention allows an improvement in the detectability of targets drowned in clutter with the help of means independent of the radial speed of the waves received. However, a technique for filtering and analyzing the radial speed can be combined with the invention.

A second advantageous embodiment of the invention is a detection device characterized in that the distance, Lr, between the phase centers of said at least two reception portions is greater than a minimum value, Lc, corresponding to the width of the coherence lobe of the non-useful signals scattered in the direction of said at least two reception portions, the width of the coherence lobe of the scattered non-useful signals being determined with the help of the dimension of the observed zone deduced from the directivity of the reception means.

A third advantageous embodiment of the invention is a detection device according to any one of the previous embodiments, characterized in that the phase centers of said at least two reception portions are situated in a horizontal plane and at the same distance from the center of the target.

A fourth advantageous embodiment of the invention is a detection device, according to any one of the previous embodiments, characterized in that it comprises a transmission antenna transmitting said collaborative source signal, the characteristics of the transmission antenna and of said collaborative source signal being known.

A fifth advantageous embodiment of the invention is a detection device, according to the previous embodiment, characterized in that:
the transmission antenna is of given width and placed approximately at the same distance from the center of the observed zone as the reception portions, the collaborative source signal transmitted by this transmission antenna being reflected on the target to form the useful signal to be detected by the reception means;
the distance between the phase centers of said at least two reception portions is greater than or equal to the width of the transmission antenna.

It is specified that the invention operates a priori with any type of transmission means. This may involve, for example, a transmission antenna of parabolic or slot type or an antenna comprising arrays of transmitters.

In the particular case of a fourth embodiment also complying with the horizontally condition of the third embodiment, the literal expression of the condition regarding the distance between the phase centers can be expressed in a very simple manner.

Let:
Le be the physical width of the transmission antenna,
λ□ be the wavelength of the signal transmitted by the transmission antenna,
⊖₃ be the angle of aperture of the transmission lobe,
R be the distance between the transmission antenna and the center of the observed zone, which is also the distance between this center and the reception portions,
D′ be the width of the zone illuminated by the transmission antenna,
Lc be the coherence width, at the level of the reception portions, of the coherent scattering lobe of the observed zone,
Lr be the minimum distance between the phase centers of said at least two reception portions.

The computation of Lr is then done in the following manner:

⊖₃=λ/Le,

generally of the order of a degree to a few degrees;

D′=R·⊖₃=RI/Le;

It may be considered that the scattering remains coherent only inside a scattering lobe whose angular width is of the order of

λ/D′.

Now,

λ/D′=λLe/λR=Le/R.

Lc=R·λ/D′=R·Le/R=Le

The detection device of the invention makes it possible to dispose the paths in reception in such a way that the phase centers of each path are situated at a distance Lr from one another. The signals gathered on each of the paths will be incoherent if

Lr>Lc i.e. Lr>Le.

Consequently, the invention makes it possible to render incoherent the signals scattered by an observed zone illuminated by a transmission antenna provided that the phase centers of the two reception paths are separated by a distance greater than the width of the transmission antenna.

An advantage of the device of the invention is that it makes it possible to be compatible with so-called “conventional” reception antennas. An adaptation of the disposition of the reception paths makes it possible to separate the reception paths in such a way that the distance between the phase centers is greater than the size of the transmission antenna. The processings of the signals received by the two reception paths can be adapted in such a way as to filter the clutter by a specific configuration for adjusting the thresholds with which the measurements of correlation coefficients are compared.

Another advantage is that the latter adaptation is compatible with the antenna architectures as well as the conventional processings of filtering and doppler processing.

Typically, the case of a conventional cruciform antenna can be adapted by separating the two reception paths in such a way that the distance between the phase centers is greater than the size of the transmission antenna.

In the general case where the device does not comprise any transmission antenna, the simplification through the distance to the target R is no longer necessarily valid.

In the latter case, it is necessary to return to the general condition which is that the two phase centers are arranged in such a way as:
on the one hand, to not both be situated in a coherence lobe of the clutter and/or noise signals in the extended potential spectral band of the useful signal, originating from the observed zone; and
on the other hand, to both be situated in one and the same coherence lobe of the wave corresponding to the useful signal to be detected.

In the case where the antennas are disposed vertically, the necessary minimum distance between the phase centers is more complex to estimate.

The presence of clutter is one of the problems in detection in a maritime setting. The invention solves this problem through the fact that sea clutter is not equivalent to a pointlike target. Indeed, the transmission antenna illuminates an elementary surface whose size is determined by the distance resolution denoted Δr on the distance axis and by the size of the azimuthal lobe on the transverse axis.

The distance resolution Δr depends on the band of the signal transmitted by the radar.

In the case of the vertical disposition, it is necessary to take account of the elevational directivity of the clutter cell. The latter is expressed by the formula:

□₃=I(□r sin(□)),

where □□ is the angle of elevation (angle between the direction of interest and the horizontal plane), and □r is the distance resolution of the radar.

The minimum spacing between the vertically aligned reception antennas is then:

R□₃=□□R/(□r sin(□)).

An observation time is then considered, during which the receptions of the signals are performed on each reception portion so as to be correlated by processing means.

A sixth advantageous embodiment of the invention is a detection device according to one of the previous two embodiments, characterized in that said at least two reception portions are situated on either side of the transmission antenna.

A seventh advantageous embodiment of the invention is a detection device according to one of the previous three embodiments, characterized in that said at least two reception portions each comprise a linear sub-array comprising a plurality of sensors.

An eighth advantageous embodiment of the invention is a detection device according to the previous embodiment, characterized in that said at least two reception portions are:
non-collinear with the transmission axis of the transmission antenna;
non-collinear with a characteristic direction of said observed zone.
This characteristic direction being able to be the non-horizontal horizon of a hillside or mountainside, or else that of aerial electrical cables so as to balance the signals received by the two antenna portions by preventing one of the portions from receiving a signal of very large amplitude and the other a signal of very small amplitude, which would be an impediment to correlation.

A ninth advantageous embodiment of the invention is a detection device according to one of the previous two embodiments, characterized in that said at least two reception portions are not mutually collinear and form a cruciform antenna.

A tenth advantageous embodiment of the invention is a detection device according to any one of the previous embodiments, characterized in that it comprises means for pivoting the receiving portions in such a way as to orient the axis joining the two phase centers according to a chosen angle.

An eleventh advantageous embodiment of the invention is a detection device according to any one of the previous embodiments, characterized in that it comprises means for displacing said at least two reception portions in such a way as to adjust in relation to a chosen distance the distance separating their phase center.

A twelfth advantageous embodiment of the invention is a detection device according to any one of the previous embodiments, characterized in that it comprises an array of a plurality of phase centers, for which the combination of the signals of the sensors taken pairwise makes it possible to estimate the dimensions of said target in several directions.

A thirteenth advantageous embodiment of the invention is a detection device according to any one of the previous embodiments, characterized in that it comprises:
an antenna processing device forming, for each of said at least two portions, from the base signals of their sensors, one or more combined signals;
a signal processing device able to filter the noise of the combined signals arising from said portions;
a device for computing the coefficients of correlation between combined signals arising from said portions;
   a device generating a detection signal when one of said correlation coefficients exceeds a first predetermined threshold.

A fourteenth advantageous embodiment of the invention is a detection device according to any one of the previous embodiments, characterized in that the correlation coefficients are normed.

The invention also comprises a detection method.

A first advantageous embodiment of the method of the invention is a detection method, passive or active, for detecting a target able to scatter a useful signal that may originate from a collaborative or non-collaborative source signal, and situated in an observed zone comprising elements able to generate clutter echoes, said clutter echoes forming, together with noise, a non-useful signal, said method comprising a step of receiving the useful signal by reception means comprising at least two distinct reception portions of like polarization, each portion comprising at least one receiver and a phase center, the useful signal, which is the source signal backscattered by the target, having a wider coherent scattering lobe than that of the non-useful signal for a considered observed wavelength and in the direction going from the target to the barycenter of said reception means, said method also comprising a step of processings allowing correlation between at least two signals constructed from signals received at a given instant t, each of said signals received being received by a receiver of one of said at least two distinct reception portions, characterized in that it comprises a step comprising disposing the phase centers of said at least two reception portions in such a way that they are both situated in said coherent scattering lobe of the useful signal and that they are not both situated in said coherent scattering lobe of the non-useful signal, so as to allow said processings to distinguish the possible useful signal from the non-useful signal, the necessary minimum distance between said phase centers being that for observing a first drop in the correlation of said at least two constructed signals.

A second advantageous embodiment of the detection method of the invention is a method according to the previous embodiment, characterized in that it comprises a step of translating and rotating said at least two reception portions, making it possible, in the absence of sufficient information on the coherence lobe of the possible useful signal and on the coherence lobe of the non-useful signal, to determine, in an experimental manner, the necessary minimum distance between said phase centers for observing a first drop in the correlation coefficient of said at least two constructed signals, this first drop being characteristic of an exit of at least one of said phase centers from the coherent scattering lobe of the non-useful signal, thereby allowing the processing means, in the case of presence of a target, to distinguish the useful signal from the non-useful signal.

A third advantageous embodiment of the detection method of the invention is a method according to any one of the previous embodiments, characterized in that it comprises a step of cooperatively transmitting a so-called collaborative source signal, able to be scattered, by a target situated in the observed zone, in the direction of said reception means.

It is known to the person skilled in the art that, in the various embodiments, the detection device can comprise:
An antenna, formed by at least two receiving portions which are, in an embodiment, two sub-arrays. The sub-arrays may or may not be cruciform, for example simple linear or surface arrays or else a computational beamforming (also known by the acronym CBF) antenna;
a stage for forming two sub-arrays such as modules allowing the realization of a so-called “monopulse” function, called a monopulse radar, or the realization of the formation of a plurality of beams by computation;
means for processing the signals received, in particular on each sub-array output. The processings relate in one embodiment to: pulse compression and/or Doppler processing;
means for computing coefficients of correlation between the outputs of the two sub-arrays in the case of a conventional antenna or of the plurality of outputs of the two sub-arrays taken pairwise for example in the case of a cruciform antenna or of a CBF linear antenna.

The invention exhibits the additional advantage that as a function of the desired probability of appearance of false alarms, the detection device can be configured in such a way as to fix a threshold of detection in the presence of a target and deduce therefrom the probability of detection of this processing as a function of the signal-to-noise ratio.

This presents one of the main advantages of the use of two receiving portions. The two portions make it possible to implement a processing of the signal aimed at considerably decreasing the signals originating from incoherent sources such as noise.

The device of the invention allows a more significant gain in detection performance for slow targets, the latter targets being in general hard to detect with conventional radars (with Doppler filter) since the clutter also produces an echo with slow radial speed.

The device of the invention allows clutter elimination spatial processing which can be combined with temporal processing. The spatial processing therefore makes it possible to render the detection independent of the speed of the targets and in this case allows instantaneous rejection of clutter signals in an extended zone. Spatial processing of the signals can be combined with processing of Doppler type.

The device of the invention can also be applied to the case of a radar with incoherent transmitter that yet makes it possible to detect targets in clutter. Indeed, conventional radars use the doppler effect to eliminate clutter, the latter having practically no speed therefore no doppler shift. This involves the use of a coherent transmitter or of a particular device to make the signal coherent again on reception.

Insofar as the device computes the correlation coefficient, it is clear that the detector is insensitive to a random phase due to the incoherent transmitter and occurring identically on each of the reception paths, previously denoted path i and path j.

The device of the invention is particularly propitious for applications in frequency ranges lying between 3 MHz and 110 GHz. In particular, for radar applications aimed generally at determining the presence and the geometry of a target. These applications can be diverse depending on whether it is desired to detect the presence of a terrestrial vehicle, of a ship or else of an aircraft.

A favored frequency band lies between 8 GHz and 12 GHz. This frequency band relates in particular to missile seekers, navigation radars, mapping radars. This band is advantageous because the wavelength of the transmitted frequencies, of the order of a few centimeters, allows a better disposition of the receiving portions of the antennas during reception. Typically, for an aperture of the antenna during transmission of ⊖₃=1°, i.e. about 1/60 rad, the approximate transmission antenna width is of the order of a meter. This configuration makes it possible for example on ships or aircraft to space an antenna portion a few meters away. For example on an airplane, a receiving portion can be installed on each of the wings.

The device of the invention is however not suitable for wavelengths of less than a tenth of a millimeter. Below 10⁻² mm, the target detection device of the invention would not be suitable. Numerous modifications would in fact have to be envisaged, in particular on the disposition of the sensors during reception, the type of sensors and their arrangement. In the latter case, the size of the transmission antenna would be too small to allow an adaptation of the two reception paths making it possible, on the one hand, to obtain two distinct reception paths with a view to computing coefficients of correlation between the signals received on each path and, on the other hand, to render the clutter sources incoherent.

The invention, according to any one of the previous embodiments, exhibits the additional advantage of being easily adaptable to existing target detection radars and therefore of allowing a decrease in the costs of progressive maintenance. Indeed, an operation of reconfiguring the receiving portions according to the invention is sufficient to improve the filtering of the disturbances arising from clutter.

The invention will be better understood with the figures and the detailed description of an exemplary embodiment.

### BRIEF DESCRIPTION OF THE FIGURES

FIG. 1: a basic diagram of a cruciform antenna of the prior art;

FIG. 2: a basic diagram of a conventional antenna of the prior art;

FIG. 3: a basic diagram of a CBF antenna of the invention;

FIG. 4: a basic diagram of an antenna of the invention resistant to scattering clutter;

FIG. 5: a basic diagram of an exemplary antenna of the invention.

### DETAILED DESCRIPTION

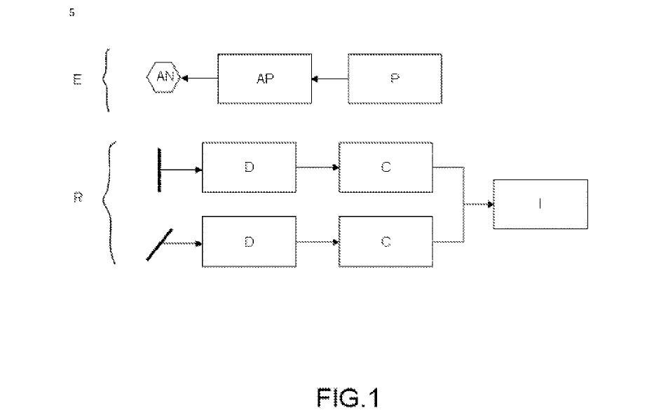

FIG. 1 represents a basic diagram of a 3D radar with cruciform antenna making it possible to analyze the data regarding distances of the target and position in space by measuring bearing and elevation. In the case of a radar of FIG. 1, the transmission is carried out by an antenna separate from the reception path(s), the two reception paths constituting the two receiving portions.

The transmission path E of the radar of FIG. 1 comprises a transmission antenna, denoted AN, a power amplification component, denoted AP, and a component for piloting the transmission according to the configuration employed for the radar, denoted P.

Furthermore, the radar comprises reception means R comprising a, so-called cruciform, reception antenna, comprising two reception paths. Each of the reception paths comprises an antenna, denoted first and second antenna. The two antennas of the device of the invention are disposed in such a way that they are not parallel. In the exemplary embodiment of FIG. 1, the first antenna forms an angle of 90° with the second antenna. In this embodiment, the two antennas are mutually perpendicular. For example, a first antenna may be disposed horizontally and the second vertically.

The two antennas in reception are formed by two linear sub-arrays which each correspond to a receiving portion.

Each reception path comprises a component allowing the processing of the signals received, in particular:
bandpass filtering means;
MTI or Doppler filtering means, the acronym standing for “Moving Target Indicator”, denoted D in FIG. 1;
pulse compression processing means, denoted C; and/or else
processing and computation means, denoted I, making it possible to correlate the signals taken pairwise on each of the reception paths;
means making it possible to perform deviometry measurements; and/or
any other processing making it possible to improve the functionalities, the performance or the robustness of the antenna and of the associated data processing.

The invention makes it possible to configure the device for detecting targets in such a way as to obtain a distance separating the phase centers of each of the two linear sub-arrays used during reception greater than the width of the transmission antenna.

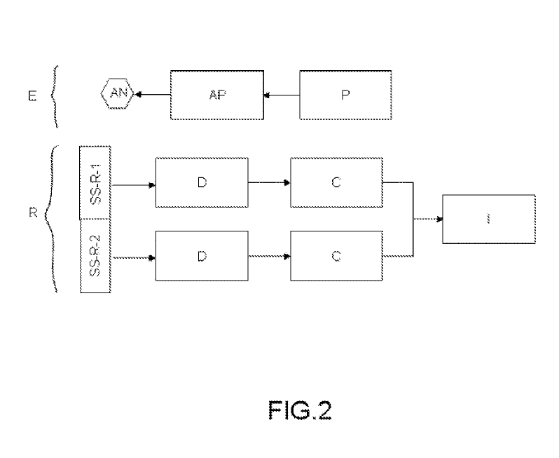

FIG. 2 represents a linear 2D conventional antenna allowing the measurement of the bearing and the distance of a target with the help of two sub-arrays denoted SS-R-1 and SS-R-2 each comprising a plurality of sensors.

In a variant embodiment, the transmission antenna AN can use the central part of the radar. The two receiving portions are then situated on either side of the transmission antenna.

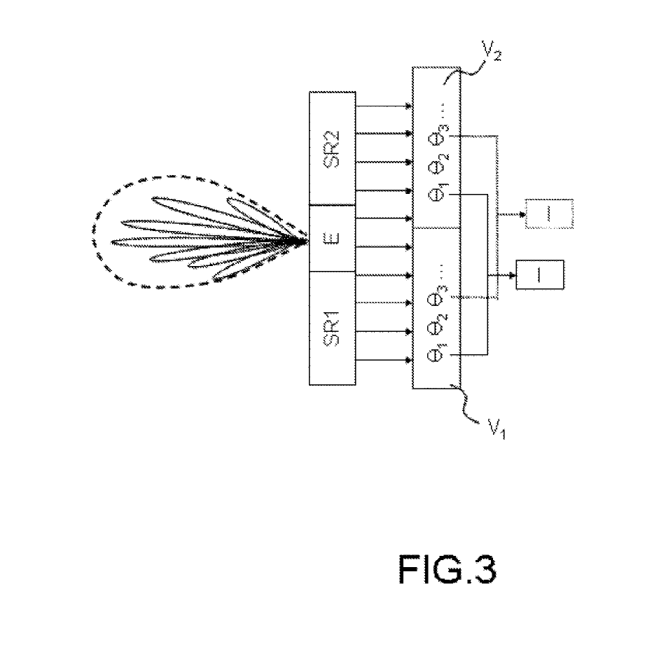

FIG. 3 represents the case of a CBF antenna which makes it possible to obtain transmission lobes, a lobe of which is represented by a dashed line, that are wider than the lobes of the 2D or 3D linear antennas, represented by a solid line. As in the case of a cruciform antenna, there are several pairs of outputs on the two reception paths. Pairwise association of the outputs makes it possible to determine the various directions polled in reception inside the transmission lobe. The processing and Doppler filtering means are not represented in FIG. 3.

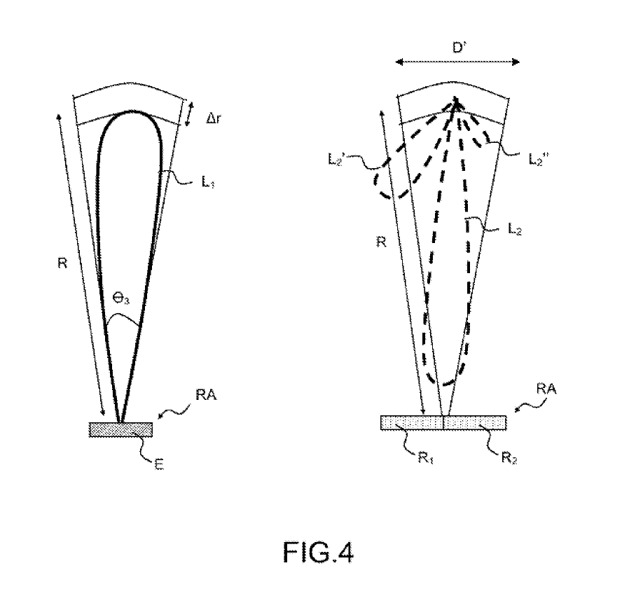

FIG. 4 represents on the left a radar denoted RA comprising an antenna in transmission, denoted E, having a transmission lobe L₁ whose characteristics are defined by the size of the transmission lobe, denoted ⊖₃. When the signal transmitted by the reception antenna intercepts at a distance R an elementary sea clutter cell, the size of the cell is defined, along the distance axis, by the distance resolution Δr of the radar and, along the transverse axis, by a width D′. The width D′ of the cell is substantially equal to the product of the size of the lobe, which is defined by its angle of aperture ⊖₃, and of the illumination distance R.

The FIG. 4 on the right represents a plurality of scattering lobes, three of whose lobes are represented in FIG. 4: L₂, L₂′ and L₂″. The radar RA comprises two reception paths denoted R₁ and R₂ whose phase centers are separated by a distance denoted Lr.

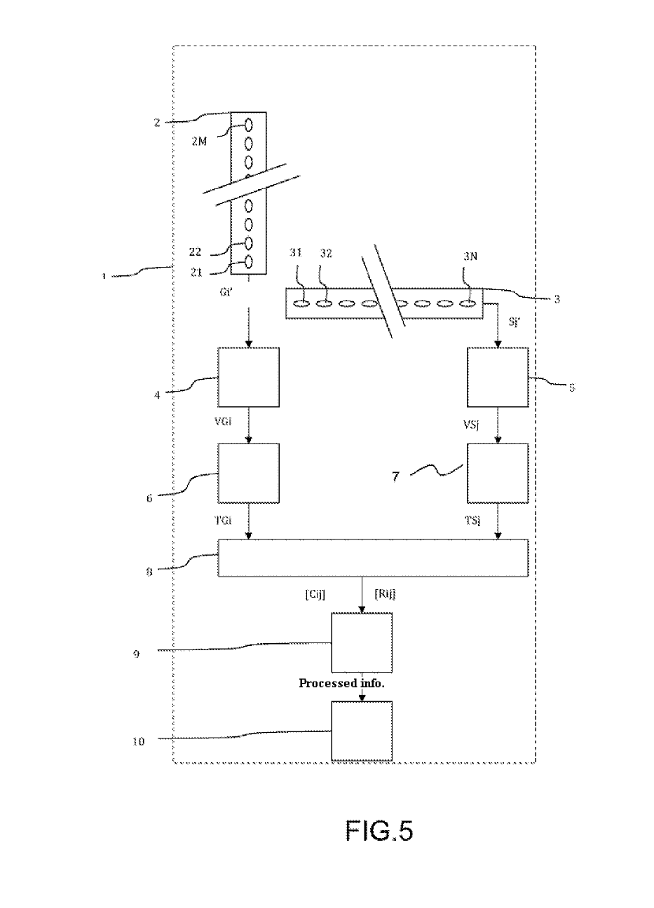

FIG. 5 represents a simplified example of an antenna. The antenna 1 comprises two sub-antennas 2 and 3. The sub-antennas 2 and 3 each comprise several sensors, respectively 21 to 2M and 31 to 3N. The sensors 21 to 2M are designed to substantially form a first line portion, that is to say a first linear path. The sensors 31 to 3N are designed to substantially form a second line portion, a second linear path.

The first and second line portions of FIG. 5 can form an angle included in the band [0°;180°] or a more restricted band of [20°;160°] so as to prevent the two portions from being substantially mutually collinear. The sensors 21 to 2M are in this instance used for the determination of the elevation of a source or of a target, while the sensors 31 to 3N are used to determine its bearing.

These sensors comprise one or more elementary sensors (not illustrated) of the appropriate type. A sensor exhibiting several elementary sensors generates a base signal from the signals of the elementary sensors in a manner known per se. Each sensor therefore generates a base signal which can undergo a particular signal processing before the antenna processing. The sensors of a portion can exhibit an identical directivity and be equidistributed over this portion. The sensors 21 to 2M respectively generate the base signals G1 to GM illustrated by Gi′. The sensors 31 to 3N respectively generate the base signals S1 to SN illustrated by Sj′. Subsequently, the index i′ will designate all the signals or numbers associated with a sensor 2i′. Thus the signal G4 is associated with the sensor 24. In a similar manner, the index j′ will designate all the signals or numbers associated with a sensor 3j′. Thus, the signal S2 is associated with the sensor 32.

An antenna processing device 4 forms a combined signal of the sensors of a portion, in a manner known per se. The antenna processing device 4 thus generates the combined signals VGi associated with the signals Gi′. An antenna processing device 5 forms a combined signal of the sensors of the other portion, in a manner known per se. The antenna processing device 5 thus generates the combined signals VSj associated with the signals Sj′. The combined signals are, inter alia, aimed at forming directivity lobes of the antenna used in reception.

Each of the sub-antennas exhibits a signal processing device which processes signals originating from the antenna processing. This signal processing device provides one or more combined signals to the output of each sub-antenna.

The signal processing devices 6 and 7 separate the useful signal from the noise, in a manner known per se. The devices 6 and 7 thus process respectively the combined signals VGi and VSj so as to generate the combined signals TGi and TSj. The signal processing devices 6 and 7 can also be coupled to the transmission device of the antenna if the antenna is of the transmitting/receiving type or of another antenna if the antenna is of the receiving only type, so as to perform a processing taking account of the transmitted signals in a manner known per se, such as pulse compression.

The computation device 8 computes the coefficients of temporal or frequency correlation (depending on whether the processings have been performed in the temporal or frequency domain) between the combined signals TGi of the first portion and the combined signals TSj of the second portion. The matrix [Cij] of the correlation coefficients is thus formed. Details relating to the computation of these coefficients are given subsequently. The computation device 8 utilizes the correlation coefficients [Cij] to detect a target and generate a detection signal. A possible manner of operation is as follows: a detection device (included in the computation device 8 in the example) compares each correlation coefficient with a predefined respective threshold. When a given correlation coefficient is below its predefined threshold, it is considered that no source or target is situated at the intersection of the two directivity lobes VGi and VSj.

When a correlation coefficient exceeds its predefined threshold, it is considered on the contrary that a source or target is situated at the intersection of the two directivity lobes. A detection signal associated with the result of the comparison can thus be generated in the form of a binary value. The set of signals can then be arranged in a matrix [Rij]. The threshold is defined as a function of the desired performance of the antenna and of the associated data processing device (including the antenna processing, the signal processing and the information processing), in terms of probability of detection and of false alarm.

In the case of the antenna processings known by the person skilled in the art, if the antenna of FIG. 5 is of the transmission/reception type, the antenna's transmission directivity pattern is that of a cross-shaped lobe and by reciprocity the reception directivity pattern is the same as for transmission. With the antenna structure presented, the association of the antenna and signal processings makes it possible to obtain the same information as that obtained by a planar antenna whose directivity lobe in reception is as fine as the center of the cross formed by the directivity lobe. Moreover, still in the case of the antenna processings known by the person skilled in the art, if the antenna of FIG. 5 does not perform any processing of correlation between the signals originating from the sub-antennas, the detection performance is that of the sub-antennas alone. This performance is markedly lower than that obtained by the antenna of the invention.

The processing device 9 can perform additional steps of information processing, to improve for example the false alarm probability performance or to determine the speed, the distance of a target or any other useful information. The processing device 9 is thus aimed at rendering the information utilizable by an operator or a processing device. This device 9 receives as input data such as the matrix [Cij], the matrix [Rij] or any similar data.

All the information determined can be furnished to the users by an appropriate display device 10, known per se.

Let us now detail an exemplary computation of a temporal correlation coefficient with the help of the exemplary embodiment represented in FIG. 5.

To carry out the computation of the temporal correlation coefficient of complex video signals (for example TGi and TSj in the example of FIG. 5), particularly suited to a radar application, it is possible to compute the coefficients of [Cij] in the following manner:

Let X(t) and Y(t) be non-periodic, second-order stationary, centered, complex random signals. The correlation function of the two signals is defined as the mathematical expectation of the product of X(t) and the complex conjugate of Y(t−T), T being the time shift between the two signals.

correlation_{XY}(τ)=E[X(t)Y*(t−τ)]=∫_{Ω}X(t,ω)Y*(t−τ,ω)dP(ω)

In the case of ergodic signals, the correlation function satisfies the following equality:

$${correlation}_{XY} ( τ ) = {lim}_{T \to ∞} \frac{1}{2 T} {\int }_{- T}^{+ T} X ( t ) Y * ( t - τ ) d t$$

In practice the integral is computed over a finite time interval which corresponds to the duration of integration.

The person skilled in the art will know how to adapt the formulae to cases of periodic, non-centered signals or ones which do not satisfy all the statistical properties cited earlier.

The normed correlation function for the two signals is defined:

$${C}_{XY} ( τ ) = \frac{{correlation}_{XY} ( τ )}{\sqrt{{correlation}_{XX} ( 0 )} \sqrt{{correlation}_{YY} ( 0 )}}$$

The use of normed correlation coefficients makes it possible to carry out target detection without worrying about the differences of levels between X and Y.

Because the correlation function tends to zero as T tends to infinity, it is considered in practice that the time shift T is bounded. For example, if T lies in the time interval [−T max, T max], then there exists a value T₀ of T for which the normed correlation function attains its maximum C_{XY}, the maximum coefficient of correlation between the two sub-antennas.

C_{XY}=|C_{XY}(τ=τ₀)|=max_{[-τ}_{ₘₐₓ}_{,τ}_{ₘₐₓ}_{]}[|C_{XY}(τ)|]

The time shift T₀ is determined by the geometry of the antenna. In the case of two identical sub-antennas secant at their center, the maximum C_{XY} is attained for T₀=0.

The coefficients of maximum correlation Cij are obtained by replacing the random signals X(t) and Y(t) with the complex video useful combined signals such as defined earlier TGi and TSj. The correlation coefficients Cij therefore form a matrix [Cij], whose values lie between 0 and 1.

A value of maximum correlation coefficient Cij greater than a predefined correlation threshold implies that at least one source or target is detected at the virtual intersection of the directivity lobes of the two sub-antennas 2i and 3j. In the case of FIG. 5, the presence of a source or target at the intersection of the elevation i and of the bearing j is determined.

Another computation method, based on utilizing real combined signals, makes it possible to simplify the computation step. The correlation coefficients are then determined in the following manner:

$${correlation}_{X , Y} ( τ ) = \frac{1}{2} ( E [ {\vert X ( t ) + Y ( t - τ ) \vert}^{2} ] - E [ {\vert X ( t ) \vert}^{2} ] - E [ {\vert Y ( t ) \vert}^{2} ] )$$

$$or else$$

$${correlation}_{X , Y} ( τ ) = \frac{1}{4} ( E [ {\vert X ( t ) + Y ( t - τ ) \vert}^{2} ] - E [ {\vert X ( t ) - Y ( t - τ ) \vert}^{2} ] )$$

This method makes it possible to obtain the correlation coefficients directly from the powers of the signals by simply performing summations or subtractions.

Moreover, it is possible to envisage excluding overly weak signals from detection. Thus, it is possible firstly to compute the denominator of the correlation coefficient mentioned hereinbelow, and compare it with a minimum threshold. When this denominator is less than the minimum threshold, the corresponding correlation coefficient is not taken into account for the detection, this amounting to giving it a zero value. It is thus possible to significantly reduce the duration of integration required for similar performance. As a variant, it is also possible to compare each threshold of the denominator with a respective threshold.

To guarantee an optimal result, it is desirable that the acquisition of the signals used for the correlation computation be synchronous.

Although a correlation computation solution has been described in the temporal domain, it is also possible to envisage performing the computations of the correlation coefficients in the frequency domain, for example for an application of the antenna to a sonar. The correlation coefficients in the frequency domain can be determined with the help of the coherence function defined in the following manner.

The Fourier transforms of the previously defined correlation functions of two signals X and Y are the inter-spectral densities (or else interaction spectral density).

Fourier Transform(correlation_{XY})(f)=S_{XY}(f)

Likewise, the Fourier transforms of the previously defined correlation functions of the signals X and Y are the power spectral densities of the signals X and Y.

Fourier Transform(correlation_{XX})(f)=S_{XX}(f)

Fourier Transform(correlation_{YY})(f)=S_{YY}(f)

The coherence function for X and Y is defined by

$${c}_{XY} ( f ) = {coherence}_{XY} ( f ) = \frac{{S}_{XY} ( f )}{\sqrt{{S}_{XX} ( f )} \sqrt{{S}_{YY} ( f )}}$$

The computation of the coherence coefficients is generalized for all analysis frequency bands Bf. In this case the computation of the coherence function becomes

$${c}_{XY} ( f ) = {coherence}_{XY} ( {B}_{f} ) = \frac{{\int }_{{B}_{f}} {S}_{XY} ( f ) d f}{\sqrt{{\int }_{{B}_{f}} {S}_{XX} ( f ) d f} \sqrt{{\int }_{{B}_{f}} {S}_{YY} ( f ) d f}}$$

Provision may be made for the antenna processing devices 4 and 5 to weight the base signals of the sensors as a function of differences of directivity or of sensitivity, before carrying out the combination (for example linear) of these signals.

The antenna processing devices can also comprise an adaptive processing, the function of which is to eliminate an interfering signal, such as that originating from a jammer or any other processing which makes it possible to improve the functionalities and the performance of the antenna and of the associated data processing.

The signal processing devices 6 and 7 for the combined signals can carry out: bandpass filterings, MTI or Doppler filterings, pulse compression processings or deviometry measurements or any other processing which makes it possible to improve the functionalities and the performance of the antenna and of the associated data processing.

Although this has not been represented, the antenna can include appropriate data processing stages, providing appropriate information to the operators. Generally, the computation of the correlation coefficients will be performed preferably after an antenna processing step and a signal processing step. The computation of the correlation coefficients will generally be followed by a step of thresholding and information processing.

The function of the information processing stages, corresponding to the devices 8 to 10 in FIG. 5, is for example to detect, locate or display the presence of a source or of a target.

In the case of discrete signals, the computation of the correlation coefficients can be performed over a number N of samples of the useful combined signals. The person skilled in the art will determine the necessary number of samples as a function of the desired probabilities of detection and of false alarm.

For example in the temporal domain, N temporal samples of the complex signals X and Y are considered and the assumption is made that the maximum C_{XY} is attained for T₀=0.

$${C}_{XY} = \frac{\vert {\sum }_{t = 1}^{N} X ( t ) \cdot Y * ( t ) \vert}{\sqrt{{\sum }_{t = 1}^{N} {\vert X ( t ) \vert}^{2}} \sqrt{{\sum }_{t = 1}^{N} {\vert Y ( t ) \vert}^{2}}}$$

### Detailed Example

In this example, the invention comprises:
a transmission antenna;
a first reception antenna disposed vertically;
a second reception antenna, whose polarization is identical to the first reception antenna, disposed horizontally.

The size of the transmission antenna is the width physically measured on the antenna itself, parallel to the horizontal plane. Depending on the type of antenna, it corresponds:
to the diameter of the parabola for a parabolic antenna;
to the width of the slot for a single-slot antenna;
to the horizontal size of the array for a reception antenna comprising an array of sensors.

The phase centers of the two reception antennas are spaced apart by a distance greater than the spatial correlation of the useful signal (signal transmitted by the transmission antenna and then scattered by the target). In the present case, where the reception and transmission antennas are disposed horizontally and equidistant from the center of the observed zone, the correlation distance in terms of bearing is of the order of the horizontal dimension of the transmission antenna.

The detection device of the invention can be combined with the signals processing means detailed in international patent application WO 05/050786 published on Feb. 6, 2005.

From the signal received on the two physically separated distinct antenna portions, the location analysis processing then ensues from the detection processing described in patent application WO 05/050786 published on Feb. 6, 2005 in which correlation coefficients cᵢⱼ are computed with the following relation:

$${c}_{ij} = \frac{\vert {\sum }_{t = 1}^{N} {x}_{i} ( t ) \cdot {x}_{j} ( t ) \vert}{\sqrt{{\sum }_{t = 1}^{N} {\vert {x}_{i} ( t ) \vert}^{2}} \cdot \sqrt{{\sum }_{t = 1}^{N} {\vert {x}_{j} ( t ) \vert}^{2}}}$$

Where xi(t) and xj(t) respectively represent the signal output by path No. i, formed with the aid of the first receiving portion in the bearing i, and the signal output by path No. j, formed with the aid of the second receiving portion in the elevation j, at an instant t.

The coefficient cᵢⱼ, causing a threshold to be exceeded, indicates the presence of a target at the bearing i and at the elevation j.

In the case of the antennas during reception comprising two linear paths, the coefficients are computed on the two sub-arrays aimed at the same bearing such as represented for example in FIG. 3.

The main lobes of the two reception paths are therefore always designed to physically intercept one another in space, around the observed zone.

The correlation coefficient Cᵢⱼ is estimated over N signal samples.

An exemplary computation of the correlation coefficients is detailed at the end of the description.

The values of the correlation coefficients of the thermal noise of distinct receiving portions tend asymptotically to the value 0 on account of the decorrelation of the thermal noise on the two measurement antennas.

As was seen above, as a function of the desired probability of appearance of false alarms, the detection device of the invention can be configured in such a way as to fix a threshold for detecting the presence of a target and the probability of detection as a function of the signal-to-noise ratio.

This is, we recall, one of the main advantages of using two receiving portions. The two portions make it possible to implement signal processing aimed at considerably decreasing the signals originating from incoherent sources such as noise.

The detection device of the invention according to the embodiment of this example makes it possible to decorrelate clutter signals across paths during reception, simply by spacing the phase centers apart by a distance greater than the width of the transmission antenna.

The clutter can then be filtered, like the thermal noise, by computing correlation coefficients of the signals originating from the reception paths of said two sub-arrays.

On a surface such as the sea, a factor termed “reflecting capacity” of a zone able to generate clutter is considered when measuring clutter effects. The reflecting capacity is defined by the ability to reflect radar waves per unit surface area.

The power gathered at the level of the radar receiver is computed by multiplying the clutter reflecting capacity by the clutter surface area intercepted by the radar lobe. This area may in this instance be very significant, depending on the size of the radar transmission lobe.

According to the present example, let us consider a radar whose transmission antenna width is 34 cm and whose wavelength in transmission is λ=3 cm, the transmission lobe then has an angle of aperture ⊖₃ of 0.0882 rad, i.e. 5°. The width D′ of the zone illuminated from a distance R=10 km is therefore D′=R□3=882 m. The width of the coherent scattering lobe of this illuminated zone near reception antennas is λ/D′=3.4 10⁻⁵ rad, i.e. about 0.0019°, hence a coherence distance Lc at a distance R where the reception portions are placed of Lc=λ/D′. R=34 cm=Le. It will therefore suffice for the distance Lr between the phase centers of the two reception paths to be spaced apart by a distance greater than Lc=Le=34 cm in order that the clutter signals picked up are incoherent and therefore filterable by a simple inter-correlation processing.

The device of the invention comprises a computer making it possible to compute the inter-correlation coefficients of the signals received by the sensors of the reception portions. The values of thresholds of the correlation coefficients are generally chosen as a function of the accepted false alarm probability or as a function of the accepted non-detection probability.

In the case where clutter is present, the target detection device allows the computations of spatial correlation of the signal arising from the zone illuminated by the transmission as well as the analysis of the computations performed. In the case of total or partial spatial correlation of the signal received from the target, the conditions of decorrelation of the non-useful signal received by at least two reception portions all holding, there will be a detection. There will not be detection in the converse case.

The target detection device of the invention improves the detections of targets in an extended clutter environment, in particular for radar or sonar applications.

1. A detection device, passive or active, for detecting a target able to scatter a useful signal that may originate from a collaborative or non-collaborative source signal, and situated in an observed zone comprising elements able to generate clutter echoes, said clutter echoes forming, together with noise, a non-useful signal, said device comprising means for receiving the useful signal, the useful signal, which is the source signal backscattered by the target, having a wider coherent scattering lobe than that of the non-useful signal for a considered observed wavelength and in the direction going from the target to the barycenter of the positions of said reception means, said reception means comprising:
at a given instant t, at least two distinct reception portions of like polarization, each portion comprising at least one receiver and a phase center; and
processing means allowing correlation between at least two signals constructed from signals received at said instant t, each of said signals received being received by a receiver of one of said at least two distinct reception portions,
wherein the phase centers of said at least two reception portions are disposed in such a way as to both be situated in said coherent scattering lobe of the useful signal and to not both be situated in said coherent scattering lobe of the non-useful signal, so as to allow said processing means to distinguish the possible useful signal from the non-useful signal, the necessary minimum distance between said phase centers being that for observing a first drop in the correlation of said at least two constructed signals.

2. The detection device, as claimed in claim 1, wherein the distance (Lr) between the phase centers of said at least two reception portions is greater than a minimum value (Lc), corresponding to the width of the coherence lobe of the non-useful signals scattered in the direction of said at least two reception portions, the width of the coherence lobe of the scattered non-useful signals being determined with the help of the dimension of the observed zone deduced from the directivity of the reception means.

3. The detection device as claimed in claim 1, wherein the phase centers of said at least two reception portions are situated in a horizontal plane and at the same distance from the center of the target.

4. The detection device, as claimed in claim 1, wherein it comprises a transmission antenna transmitting said collaborative source signal, the characteristics of the transmission antenna and of said collaborative source signal being known.

5. The detection device, as claimed in claim 4, wherein:
the transmission antenna is of given width and placed approximately at the same distance from the center of the observed zone as the reception portions, the collaborative source signal transmitted by this transmission antenna being reflected on the target to form the useful signal to be detected by the reception means;
the distance between the phase centers of said at least two reception portions is greater than or equal to the width of the transmission antenna.

6. The detection device as claimed in claim 4, wherein said at least two reception portions are situated on either side of the transmission antenna.

7. The detection device as claimed in claim 4, wherein said at least two reception portions each comprise a linear sub-array comprising a plurality of sensors.

8. The detection device as claimed in claim 7, wherein said at least two reception portions are:
non-collinear with the transmission axis of the transmission antenna;
non-collinear with a characteristic direction of said observed zone.

9. The detection device as claimed in claim 7, wherein said at least two reception portions are not mutually collinear and form a cruciform antenna.

10. The detection device as claimed in claim 1, wherein it comprises means for pivoting the receiving portions in such a way as to orient the axis joining the two phase centers according to a chosen angle.

11. The detection device as claimed in claim 1, wherein it comprises means for displacing said at least two reception portions in such a way as to adjust in relation to a chosen distance the distance separating their phase center.

12. The detection device as claimed in claim 1, wherein it comprises an array of a plurality of phase centers, for which the combination of the signals of the sensors taken pairwise makes it possible to estimate the dimensions of said target in several directions.

13. The detection device as claimed in claim 1, wherein it comprises:
an antenna processing device forming, for each of said at least two portions, from the base signals of their sensors, one or more combined signals;
a signal processing device able to filter the noise of the combined signals arising from said portions;
a device for computing the coefficients of correlation between combined signals arising from said portions;
a device generating a detection signal when one of said correlation coefficients exceeds a first predetermined threshold.

14. The detection device as claimed in claim 1, wherein the correlation coefficients are normed.

15. A detection method, passive or active, for detecting a target able to scatter a useful signal that may originate from a collaborative or non-collaborative source signal, and situated in an observed zone comprising elements able to generate clutter echoes, said clutter echoes forming, together with noise, a non-useful signal, said method comprising a step of receiving the useful signal by reception means comprising at least two distinct reception portions of like polarization, each portion comprising at least one receiver and a phase center, the useful signal, which is the source signal backscattered by the target, having a wider coherent scattering lobe than that of the non-useful signal for a considered observed wavelength and in the direction going from the target to the barycenter of said reception means, said method also comprising a step of processings allowing correlation between at least two signals constructed from signals received at an instant t, each of said signals received being received by a receiver of one of said at least two distinct reception portions, wherein it comprises a step consisting in disposing the phase centers of said at least two reception portions in such a way that they are both situated in said coherent scattering lobe of the useful signal and that they are not both situated in said coherent scattering lobe of the non-useful signal, so as to allow said processings to distinguish the possible useful signal from the non-useful signal, the necessary minimum distance between said phase centers being that for observing a first drop in the correlation of said at least two constructed signals.

16. The method as claimed in claim 15, wherein it comprises a step of translating and rotating said at least two reception portions, making it possible, in the absence of sufficient information on the coherence lobe of the possible useful signal and on the coherence lobe of the non-useful signal, to determine, in an experimental manner, the necessary minimum distance between said phase centers for observing the first drop in the correlation coefficient of said at least two constructed signals, this first drop being characteristic of an exit of at least one of said phase centers from the coherent scattering lobe of the non-useful signal, thereby allowing the processing means, in the case of presence of a target, to distinguish the useful signal from the non-useful signal.

17. The method as claimed in claim 15, wherein it comprises a step of cooperatively transmitting a so-called collaborative source signal, able to be scattered, by a target situated in the observed zone, in the direction of said reception means.
